(19) United States
(12) Patent Application Publication
(10) Pub. No.: US 2019/0199866 A1
(43) Pub. Date: Jun. 27, 2019

(54) TYPE PRO

(71) Applicant: Robert George Foster, Mount Vernon, NY (US)

(72) Inventor: Robert George Foster, Mount Vernon, NY (US)

(21) Appl. No.: 15/854,735

(22) Filed: Dec. 26, 2017

(51) Int. Cl. H04N 1/00

(52) U.S. Cl. CPC H04N 1/00278; H04N 1/00384; H04N 1/00339; H04N 1/00129; H04N 1/00392

(57) ABSTRACT

The Type-Pro is a multi-functional secured device for writing or creating a document and printing said document on the device internal printer, a means for space constrains by compacting the need for multiple devices into a digital format on one device, preventing unauthorize exchange of said device apparatus, controlled data transfer; installing the audio digital and/or tv-pro cards will affix these apparatus exclusively to the device it was initially installed on.

The Type-Pro is a multi-functional secured device for writing or creating a document, and printing said document from the device internal printer. Eliminates space constrain by compacting the need for multiple devices into a digital format on one device. It can be utilized as an am/fm digital radio, play digital audio and view television via on-air or cable connection; with the use of the audio digital and tv-pro cards.

### BACKGROUND ON THE INVENTION

The TYPE-PRO is a multi-functional device designed for use in secured and/or controlled environments, whereas in some instances, computers are not allowed. The Type-Pro could also be applied in environments such as business, educational institutions, and undeveloped infrastructures. It can serve beneficial for those who rather live in a hack-free world because the device has no internet connection.

In secured environments to my knowledge since the dawn of the Typewriter there has never been a product designed to be safely utilized in places such as corrections and other type of facilities. Over the decades society has fast track with most media developed today are in digital format (as in New York State Facilities are still listening to cassette tapes). In places where personal property limitations are an issue (i.e., radio, television, books, photographs, letters) base on space, the Type-Pro device is a host that eliminates space constrains by compacting the need for multiple devices into a digital format on one device.

While there are prior art that offer Tablets for keeping individuals abreast of current affairs and provide entertainment, these devices can be considered a security risk. Other devices—computers, are configured with mass amount of processing power and capabilities surpassing that of this machine; utilizing these devices in a secured environments would be a security challenge; whereas its capabilities can be misused. This multifunctional device the Type-Pro affords a demographic of individuals access to (a fraction of) an advance technology by eliminating the treat of misused which violate regulation and the law.

The device casing is transformable; thereby enabling the built in printer function, FIG. 2B gives a visual wherein the print paper tray feeds blank paper into the print mechanism for printing. Unlike prior art that may require a docking device or connecting to an external printer for printing; the Type-Pro is a compact all-in-one light weight device.

### SUMMARY OF THE INVENTION

The Type-Pro is a process that offers a variety of beneficial functions with various possibilities. The device interface is use for writing or creating a document or print said document on the device built in printer. It provides an opportunity to multitask by listening to broadcast radio and/or digital music; reading e-books or watching television while writing a document—college, legal, personal, or viewing family photographs.

The device offers a means for space constrains whereby compacting the need for multiple devices into a digital format on one device; it also offers a variety of secured features that are ideal in a secured and controlled environments by preventing unauthorized exchange of the apparatus, providing controlled data transfer and much more.

### DETAILED DESCRIPTION OF THE INVENTION

A preferred embodiment of the Type-Pro device illustrated in FIG. 1A (prospective view) FIG. 1C (open view), and FIG. 1D (rear view). This depiction highlight the various functionality of said device. In its close position FIGS. 1A and 1B, the screen housing 32 is released by squeezing button 30 which will ajar the screen, whereby it can be manually open to a desired position of up to 130 degree angle; with access to the interface.

On the top of screen housing 32 shown in FIGS. 1A, 3, and 4—beveled in said casing (top/rear) is the paper holder tray 20 that can be open for the printer function by pulling it up from notches 22. FIG. 29 further illustrates the printer mechanism with the paper tray 20 position opened for the print function process. Creating a document on-screen and placing paper in said tray now enable the print command. The device utilize a replacable print cartridge depicted by 21 (also FIG. 5A-5B) so that one sheet of paper selected by 24 will enter the cartridge thereby it is printed on, and enter into a set of contiguous rollers to egress a printed document to rest into print tray 10.

Audio can be heard from the stereo speaker system 6A and 6B shown in FIGS. 1A and 1B, or by headphones connected to an ⅛ jack 2A (as shown in FIG. 2C), with volume being controlled on screen or by the manual volume control 4. Card slot 3 depicted in FIG. 2C and further illustrated in FIG. 2D an enlarged view, with apparatus 201 and 202—an audio digital and tv-pro cards respectively, are not designed for shared use amongst said device or any other devices; these apparatus once installed will affix exclusively to that device. This function is utilizes for secured and controlled environments preventing unauthorized exchange of said apparatus and providing controlled transfer of data. No standard peripheral connections are used for said cards or the I/O Port.

The Type-Pro device can function as digital radio and television, with all its features viewed on screen. Enabling this process will require the installation of an “Audio Digital Card” and/or the “TV-Pro Card”.

The Audio Digital Card offers an am/fm digital radio and Digital Audio Player. The digital radio has features such as Radio Data System (RDS) on screen, with Preset Stations that can be customized, Local & Distance switch, Stereo/Mono function with Mega-Bass, and Equalizer (EQ). The Digital Audio Player will play digital music. These songs or albums, purchased can be loaded on the device.

This application will allow you to create a variety of play lists for listening preferences, categories, and playback—as in sequential or random play mood. The menu bar will read: File, View, Format, Mixer, and Menu; with this mixer tab in all functions of the Type-Pro Suite giving access to the Sound System. All audio generated from the TV, Radio, Audio Player will be route through the digital mixer. Each channel will have a left and right mute, volume control and EQ adjustments. The audio from these channels are controlled by a master L/R volume control. The device's manual volume 4 in FIG. 2C will move the master volume in unison at whatever level it was set.

The TV-Pro card in addition to the television; offers additional applications, including: Digital Photo Album, Book Reader, and Vision. These applications can be used automatically or optional upon installation. Once the card is inserted into the device. The cards will not be required to be inserted for these applications continued operation. However, if the cards are removed, it will disable the radio and/or the television respectively.

### DESCRIPTION OF DRAWINGS

The TYPE-PRO device dimensions are: 12½″W×10½″D×2¾″H. The height changes with the screen open at a 90 degree angle, this height becomes 10¾″ inches tall.

FIG. 1A—sheet 1, shows a prospective view of the device; illustrates the many different features of the machine. (i.e., The display housing 32, which attaches to the device with a screenhousing hinge 34. The screen release button 30, which when pressing will ajar the display housing whereas, it can be manually opened to a desire angle up to a 130 degree max).

On the top, and/or back of the display housing 32, beveled in its casing is the flip-out paper tray 20, designed to feed blank paper into the printer paper intake mechanism 24—when the display housing is open. The flip-out paper tray 20 is manually raised into position by inserting your left and right index fingers into the concave beveled notches 22, by pulling up and out.

FIG. 1B—sheet 2, shows a front view of the device, with its left and right speaker system 6A/B, and the print tray 10. The print tray-extender 12, which is manually pulled out by griping on to the lip 14, and pulling it out away from the device.

FIG. 1C—sheet 2, shows an open view illustrating the device interface. This includes a trackpad 40, keyboard 42, and color display LED/CD screen 44, and the display housing hinge 34.

FIG. 1D—Sheet 3, shows the rear of the device with the print cartridge door 8 inplace. 203 illustrates the I/O Port, where all data is transfered via portable drive to the device. Furthermore, there are two 75 ohms connectors on the lower left rear 205 A, for the audio digital card am/fm antenna, and 205 B for the tv-pro card on-air/cable antenna. The device main power switch and AC power connection are depicted at the lower right rear 207 A and B respectively.

FIG. 1E—sheet 5, illustrate the print cartridge housing door 8. The latches 210 and 211 allows its release from the print cartridge housing, if it was snapped into the closed position. In addition, the print cartridge door has three footings 214 A/B/C that fits into the groves in the print cartridge housing.

FIG. 2A—sheet 6, is a left side view of the device, with 5A and 5C depicting the left side rubber footings.

FIG. 2B—sheet 7, is an illustration of the machines print mechanism; the rear of the display housing 32, which also houses the paper-holder tray 20, operates on two sets of different size slidably hinges. The shorter set 18A allows the top of tray 20 to open closer to the opening in the display housing; and the longer set 18B open said tray further away from the opening at the bottom of the display housing—giving the tray an offset.

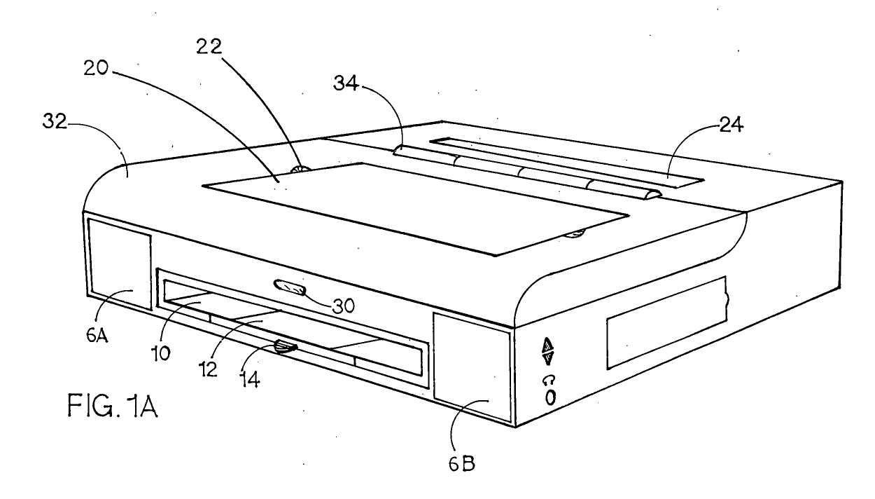

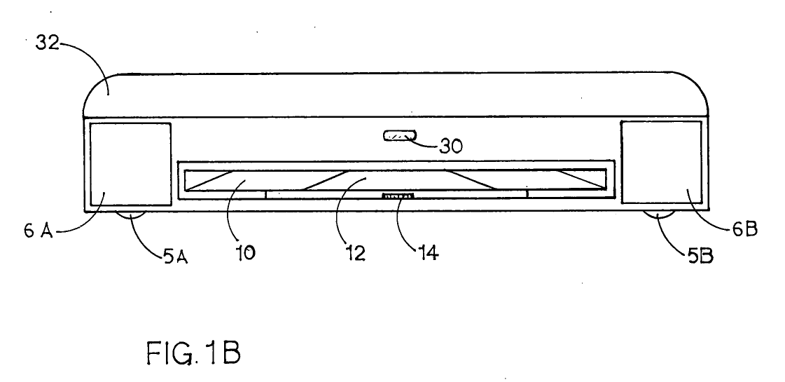

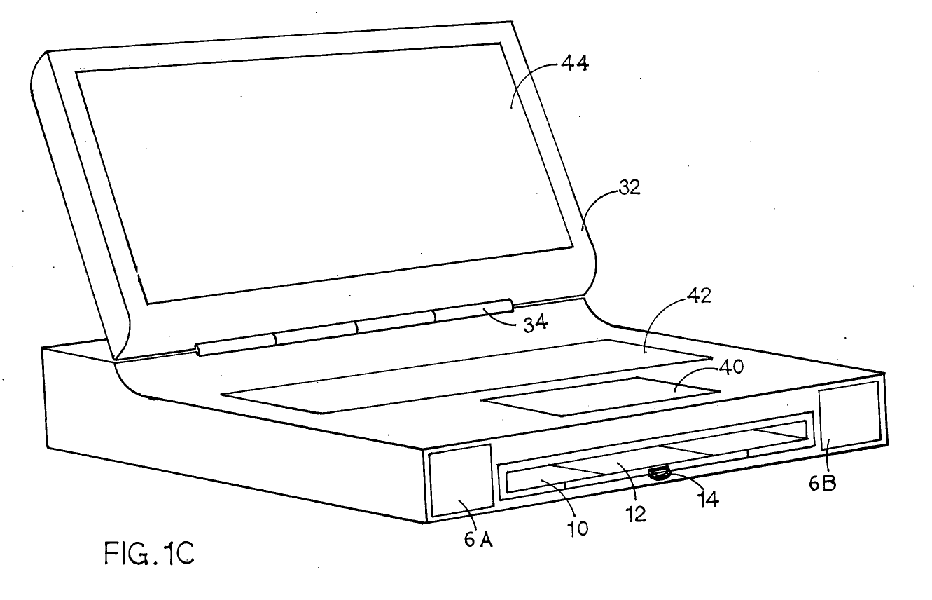

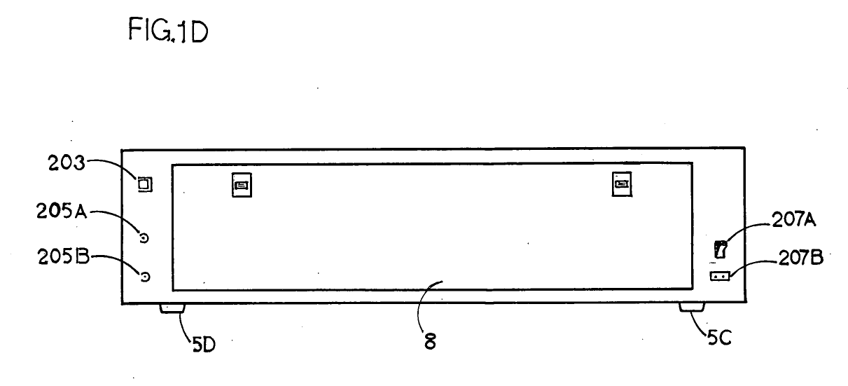

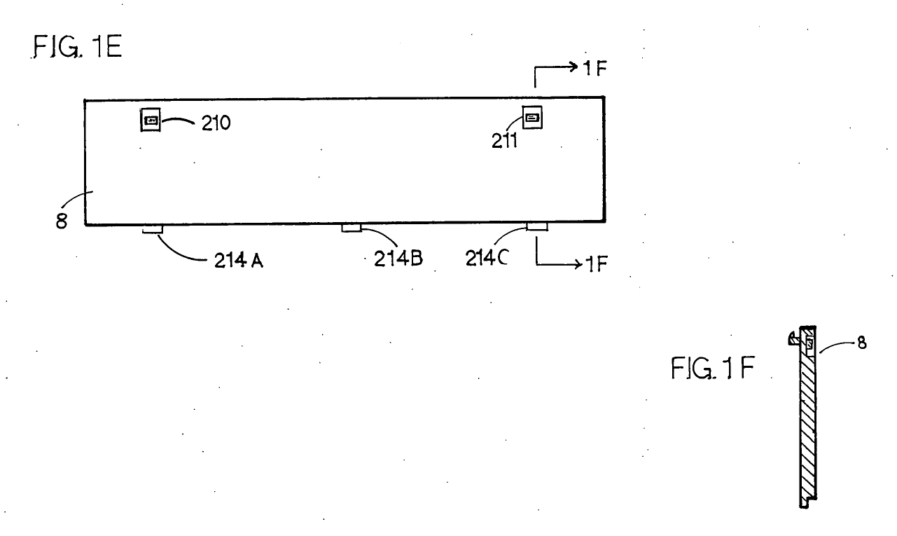

The paper intake mechanism 24 allows one sheet of paper to be fed to the removable print cartridge 21. The printed page then enters a contiguous set rollers 16 and 17. Roller 16 is motor driven 48, which aide the paper into the print tray 10. The extendible print tray 12 allows the printed sheet to stay in the print tray, by increasing its depth. The stop for the extendible print tray depicted by 11; thereby, allowing the tray to extend three-quarter of the way out, hindering said tray from being totally removed. Above print tray 10 is the device circuitry housing 49. The keyboard 50, the processing system circuit board 52, and the track-pad circuit board housing 54.

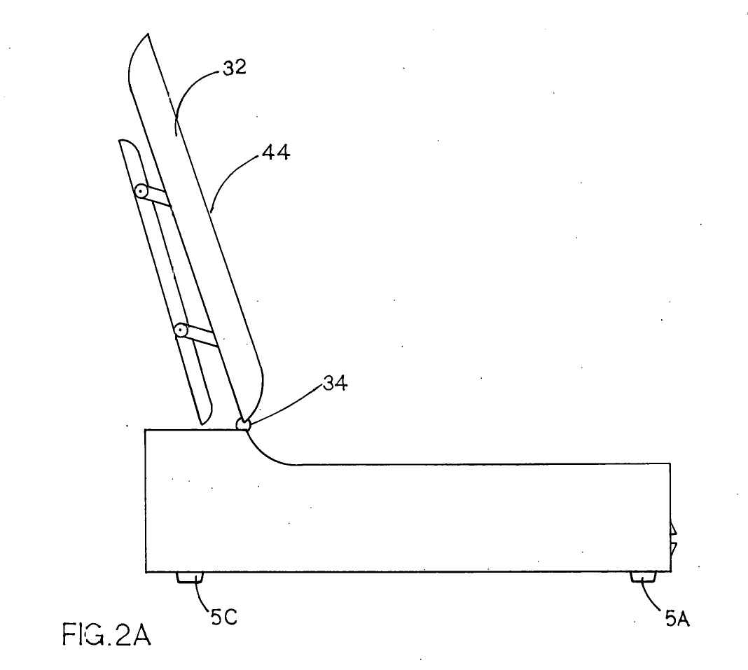

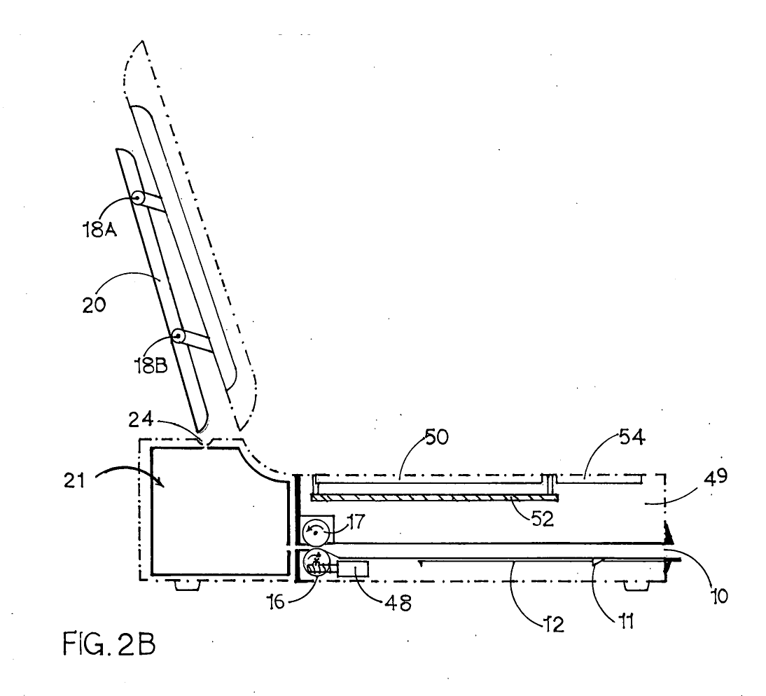

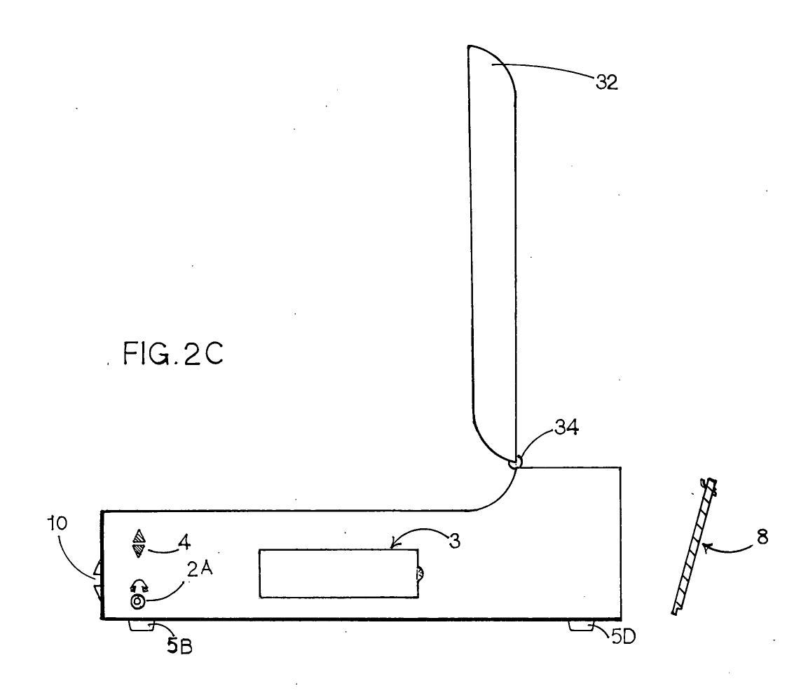

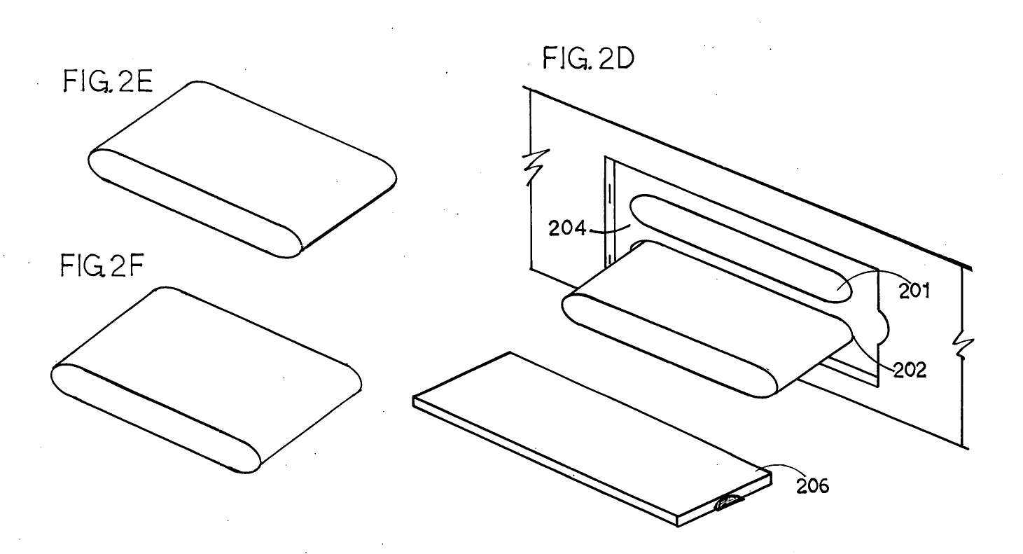

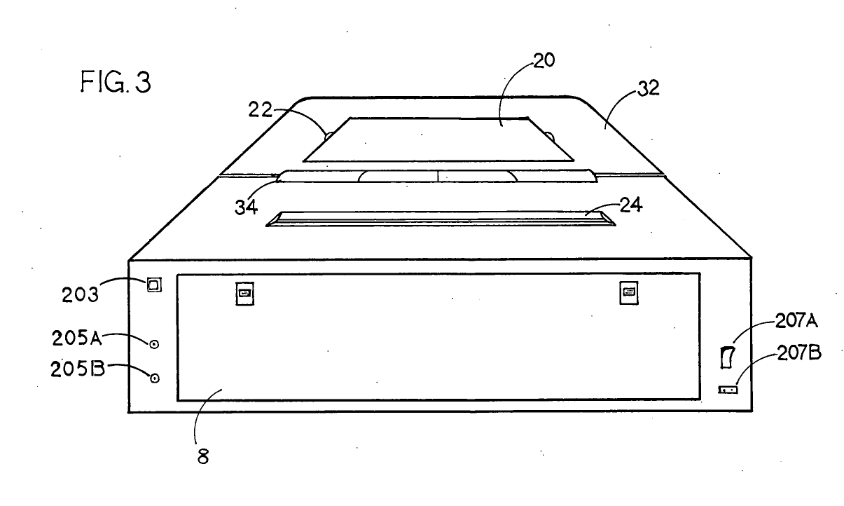

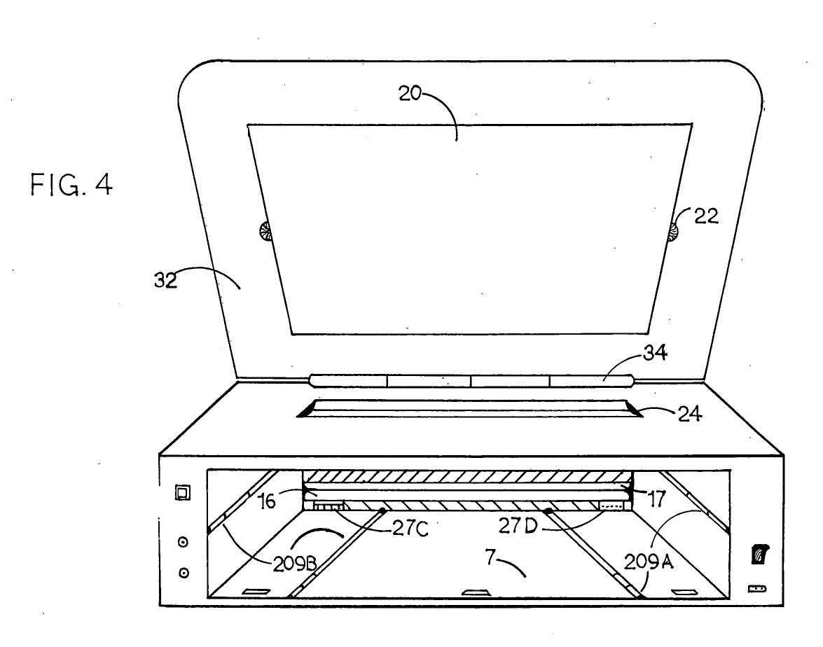

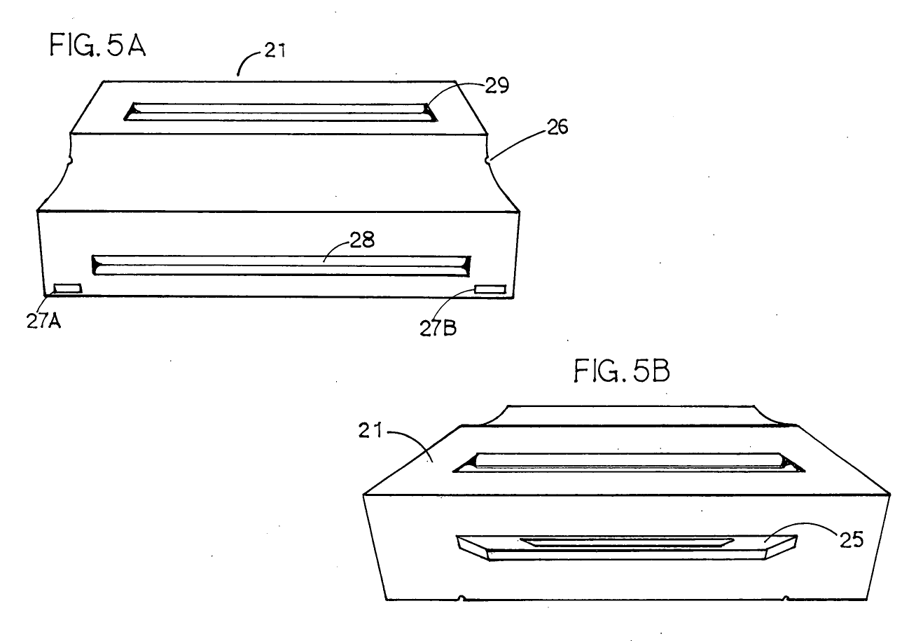

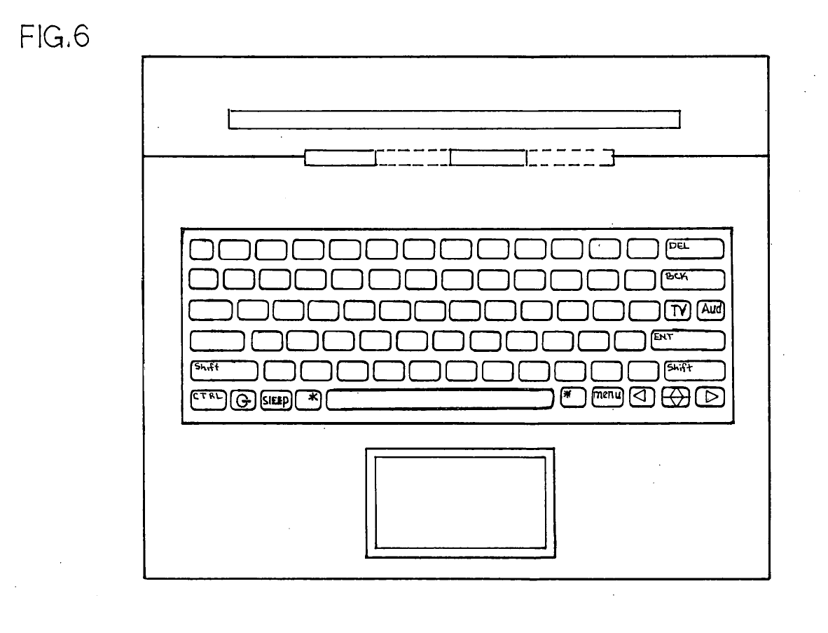

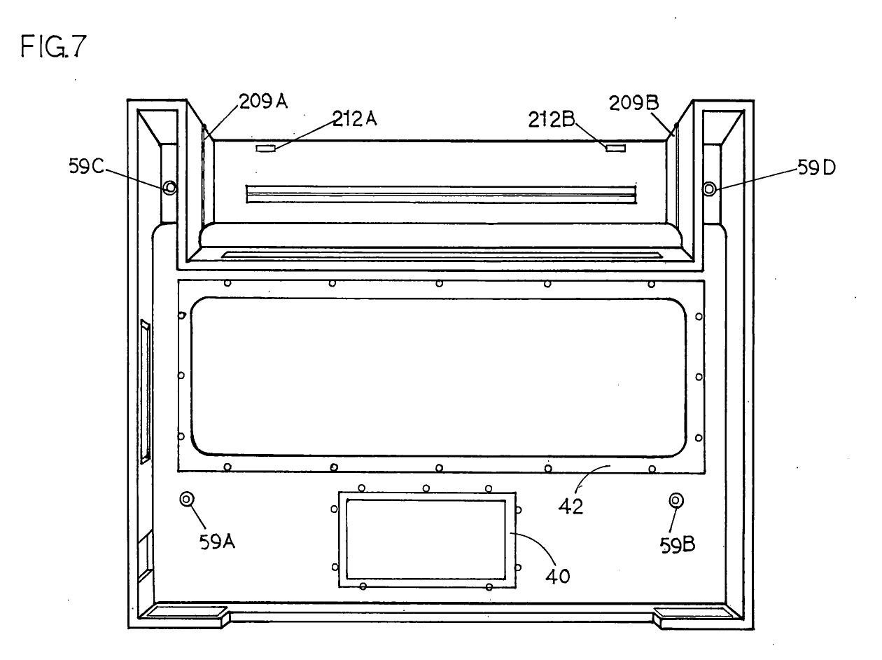

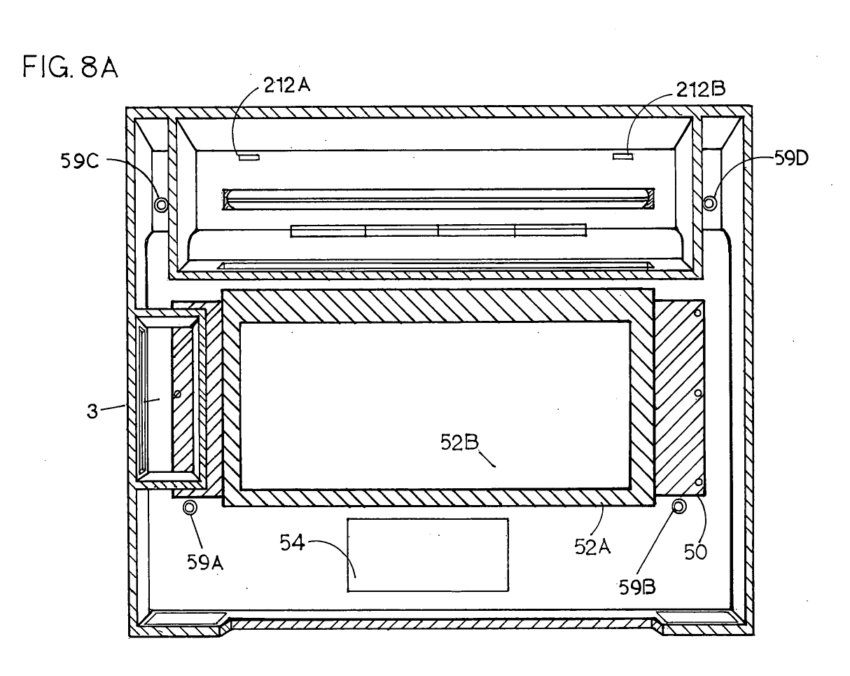

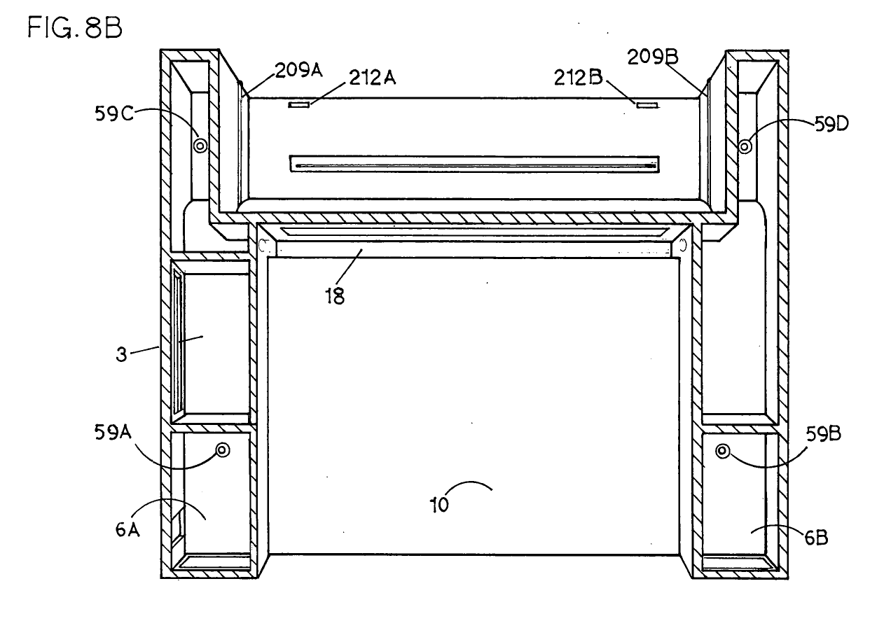

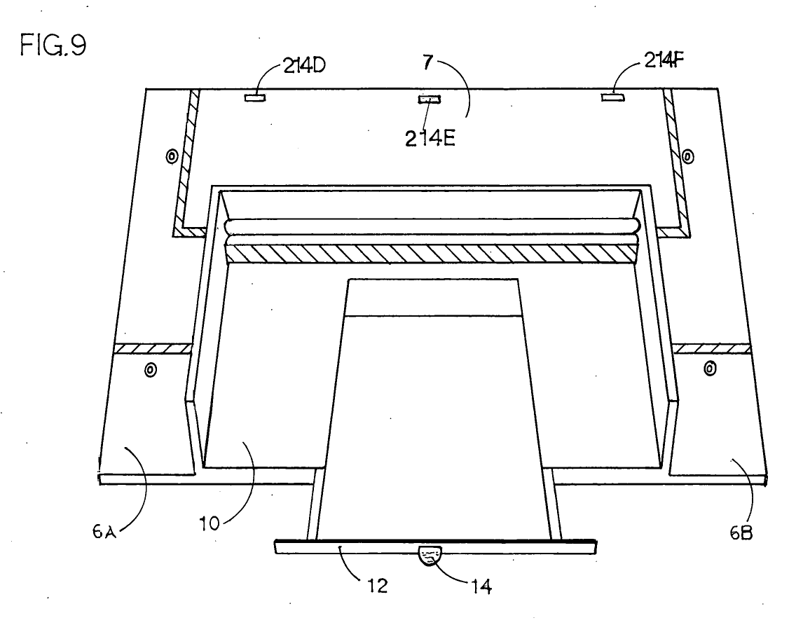

FIG. 2C—sheet 8, is a right side view of the device; its manual volume control 4, accompanied by a ⅛ female headphone connection 2A. The device card slots housing 3, with its cover in place (see an enlarged view FIG. 2D), with the cover off there's two slots that are a means for enabling the device to there's a view of the display housing 32 at a 90 degree angle, which is connected by its hinge 34; the print cartridge housing door depicted by 8.

FIG. 2D—sheet 9, is an enlarged view of card slot 3 with its cover 206 off and a depiction of a card being inserted or removed. The slots are unique to each card there composed of differential pin-set so that slot 201 will only accept the digital audio card, and slot 202 for the tv-pro card.

FIG. 2E, on said page further illustrates the Audio Digital Card, and FIG. 2F the TV-Pro Card; both cards are of the same demension.

FIG. 3—sheet 10, is a prospective view of the Type-Pro device rear, with the print cartridge door 8, closed in place.

FIG. 4—sheet 11, is a prospective rear view of the machine with its display-housing 32, and the print cartridge housing 7, opened. On the rear of the display housing, 20 depict the paper holder-tray beveled in its closed position, with notches 22. The screen housing hinge and paper intake mechanism 24 are shown.

The print cartridge housing shows a multitude of convex grove tracks 209 A and B that keeps the cartridge positioned in place once inserted; these convex groves are notched to serve as locks (not shown) once the cartridge is inserted in place. This further aide with maintaining continuos connections of 27 C and 27 D for power and data require for continuos operation of the cartridge.

FIG. 5A—sheet 12, illustrate the print cartridge 21. Paper enters the cartridge through the top opening 29 and a printed page exit through the front opening 28; said page is fed to the print tray rollers 16 and 17. Power and data for the operation of the cartridge are provided through connections 27A and 27B recess male connections on the cartridge, and female connections within the device are 27 C and 27 D.

FIG. 5B further shows the rear of the print cartridge with its handle for easy removal from its housing.

FIG. 6—sheet 13, depicts the users interface that has some special key features for quick launch of the TV-Pro and Audio Digital function; other addition are menu, and sleep function key.

FIG. 7—sheet 14, is an illustration of the underside of the top cover housing, the opening for the keyboard 42, and trackpad 40. The device is secured to the base as one unit with four screws 59 A, B, C, and D; also a series of clips not shown.

FIG. 8A—sheet 15, depict a view of how the circuit boards are secured in the device housing. The keyboard 50 is the first board in and secured by screws, layered below is a platform 52A; whereby the main circuit board 52B will be mounted. The trackpad is mounted and secured in its opening 54.

FIG. 8B—sheet 16, depicts a closed off section of 49, where the device circuitry are housed with cooling system in place (not shown) for the processor. This separation establishes the top of the print tray housing 10; and 18 depict the recess for the print tray roller 17. The perimeter of the top cover housing fits onto the base of the device (shown in FIG. 9).

FIG. 9—sheet 17, is a view of the devices' base which encompass closing off several sections, such as: the print tray housing 10, left/right speaker housing 6A and 6B, and the print cartridge housing. Roller 16 and 17 is dispose on the base wherein roller 17 fits into the recess 18—shown in FIG. 8B. Depicted in this section is the print tray extender 12, positioned to give the tray depth. The print cartridge housing door 8 has three footings 214 A, B, and C. These footings secures the bottom of the door in place, as it fits' into the groves of 214 D, E, and F; the same as latches 210 and 211 will secure the top of the door in place.

1. The invention is a process for a multi-functional device designed for secured and controlled environments comprising:
a. A means for space constrains whereby compacting the need for multiple devices into a digital format on one device.
b. wherein not surpassing said device capabilities to be programable.

2. Preventing unauthorize exchange in a controlled and secured environment of an apparatus; providing controlled data transfer comprising:
a. A means for an audio digital and tv-pro cards as an apparatus to enable the process of digital device/s and applications on each card,
1. providing a process for digital radio, music, not limited to other forms of radio.
2. providing a process for viewing digital photographs, videos/lectures, e-books, educational/legal materials, and formats.
3. A means to disable said radio and/or television process by removing audio digital or tv-pro card but allow the additional applications to operate.
b. A process for said cards installed on the device will affix exclusively to that device, whereby said cards will only operate on the initial device it was installed on and will not work on another device.
c. a means for controlled data transfer to and from the device, thereby requiring a secured adapter wherein said device I/O port is compatible, and the adjoining connection is compatible with standard connection.

3. The device casing is transformable as a means for enabling the print function, wherein the embodiment of the casing can be changed so that the screen housing, beveled in its top/rear a print paper tray controlled by two set of hinges allows said tray to be opened to accommodate paper for printing, whereby said paper enters the print mechanism wherein the document is printed and egress from the front of the device.
